(19) United States
(12) Patent Application Publication
(10) Pub. No.: US 2019/0368450 A1
(43) Pub. Date: Dec. 5, 2019

(54) FUEL SUPPLY DEVICE

(71) Applicant: AISAN KOGYO KABUSHIKI KAISHA, Obu-shi, Aichi (JP)

(72) Inventors: Yoshihiko HONDA, Obu-shi (JP); Akira HAMAJIMA, Obu-shi (JP); Kazuki TAGA, Chita-gun (JP)

(21) Appl. No.: 16/477,242

(22) PCT Filed: Dec. 7, 2017
(86) PCT No.: PCT/JP2017/044020

§ 371 Date: Jul. 11, 2019

(51) Int. Cl. F02M 37/08; B60K 15/077; B60K 15/03; F02M 37/10

(52) U.S. Cl. CPC F02M 37/08; B60K 15/077; B60K 2015/0319; F02M 37/10; B60K 15/03

(57) ABSTRACT

A fuel supply device may include a pump unit disposed in the fuel tank and including a fuel pump configured to eject the fuel in the fuel tank; a set plate fixed at an opening of the fuel tank; a controller fixed on the set plate outside the fuel tank and configured to control electric power supplied to the fuel pump; a connecting member extending from the set plate toward the pump unit within the fuel tank and connecting the set plate and the pump unit; and a conductive member having an electric component fixed thereon, extending from the controller along the connecting member within the fuel tank, and fixed to the connecting member.

### TECHNICAL FIELD

The technique disclosed herein relates to a fuel supply device.

### BACKGROUND ART

Patent Literature 1 describes a fuel supply device that ejects fuel in a fuel tank mounted on a vehicle and supplies the fuel to outside of the fuel tank. The fuel supply device described in Patent Literature 1 includes a pump unit, a set plate, a connecting member, and a controller. The pump unit is disposed in the fuel tank. The pump unit includes a fuel pump that ejects the fuel in the fuel tank. The set plate is fixed at an opening of the fuel tank. The connecting member extends from the set plate toward the pump unit within the fuel tank and connects the set plate and the pump unit. The controller is fixed on the set plate outside the fuel tank. The controller controls electric power supplied to the fuel pump. Further, the controller includes a noise filter that reduces noise occurring when the electric power is supplied to the fuel pump. The noise filter is constituted of a plurality of electronic components. Specifically, the noise filter is constituted of a capacitor, a coil, and the like. These electronic components of the noise filter (such as the capacitor and the coil) are fixed to the controller.

### CITATION LIST

### Patent Literature

Patent Literature 1: Japanese Patent Application Publication No. 2013-015073

### SUMMARY OF INVENTION

### Technical Problem

In the fuel supply device described in Patent Literature 1, the plurality of electronic components (such as a capacitor and a coil) are fixed to the controller, which results in an increase in a physical size of the controller and makes it difficult to dispose the controller between the vehicle and the fuel tank when the fuel supply device is mounted on the vehicle. Further, if an increase in electric power supplied to the fuel pump is desired, the physical size of the controller would further increase accordingly, which makes the above-mentioned problem more serious. Therefore, the present disclosure herein provides a technique capable of suppressing an increase in a physical size of a controller located outside a fuel tank.

### Solution to Technical Problem

A fuel supply device disclosed herein may be configured to eject fuel in a fuel tank and supply the fuel to outside of the fuel tank. The fuel supply device may comprise a pump unit disposed in the fuel tank and comprising a fuel pump configured to eject the fuel in the fuel tank; a set plate fixed at an opening of the fuel tank; a controller fixed on the set plate outside the fuel tank and configured to control electric power supplied to the fuel pump; a connecting member extending from the set plate toward the pump unit within the fuel tank and connecting the set plate and the pump unit; and a conductive member having an electric component fixed thereon, extending from the controller along the connecting member within the fuel tank, and fixed to the connecting member.

With such a configuration, the conductive member extends from the controller and the electronic component is fixed on the conductive member, thereby the number of electronic components in the controller can be reduced. That is, in the above configuration, the number of electronic components (such as a capacitor and a coil) in the controller can be reduced by fixing the electronic component, which is conventionally fixed to the controller, to the conductive member. The electronic component fixed to the conductive member can be accommodated in the fuel tank because the conductive member extends within the fuel tank. Thereby, an increase in a physical size of the controller located outside the fuel tank can be suppressed.

In the fuel supply device, the conductive member may extend in a vertical direction.

In a vehicle on which the fuel supply device is mounted, an antenna for receiving radio waves may be installed at an upper portion of the vehicle in the vertical direction (for example, at a roof of the vehicle). Furthermore, in the fuel supply device that includes the conductive member, noise may occur from the conductive member. For example, when electric power is supplied to the fuel pump, noise may occur from the conductive member. At this time, if the noise occurring from the conductive member is radiated in the vertical direction, there is a possibility that the antenna installed at the upper portion of the vehicle in the vertical direction would thereby be adversely affected. However, since in the above configuration, the conductive member extends in the vertical direction, the noise occurring from the conductive member is radiated in a direction orthogonal to the vertical direction (i.e., in a horizontal direction). Consequently, the noise occurring from the conductive member can be suppressed from adversely affecting the antenna of the vehicle.

The conductive member may be embedded in the connecting member.

With such a configuration, the conductive member is embedded in the connecting member, thus a space occupied by the conductive member and the connecting member within the fuel tank can be reduced. The conductive member is embedded in the connecting member, for example, by insert molding.

The electric component may be a component of a noise filter configured to remove noise occurring when the electric power is supplied to the fuel pump.

Such a configuration allows the noise filter configured to remove the noise to be disposed in the fuel tank. Since the noise filter does not need to be disposed outside the fuel tank, a configuration outside the fuel tank can be reduced in size. That is, an increase in the physical size of the controller located outside the fuel tank can be suppressed. The component of the noise filter includes, for example, a capacitor, a coil, and the like.

The fuel supply device may further comprise a ground member connected to a ground terminal of the controller. The ground member may extend from the controller along the connecting member within the fuel tank and may be fixed to the connecting member.

With such a configuration, the ground member extends from the controller within the fuel tank, so an increase in the physical size of the controller can be suppressed.

The conductive member may comprise a base member constituted of a copper-based material, and a coating member constituted of a tin-based material and coating the base member.

With such a configuration, resistance of the conductive member to the fuel in the fuel tank can be improved.

The pump unit may be configured to discharge a part of fuel ejected from the fuel pump toward the conductive member.

With such a configuration, the conductive member can be cooled by the fuel discharged toward the conductive member.

The fuel pump may comprise a brushless motor.

In a case where the fuel pump includes a brushless motor, a configuration of the controller that controls the electric power supplied to the fuel pump could be complicated and the physical size of the controller could be large, compared to a case where the fuel pump does not include a brushless motor (for example, a case with a motor with a brush). In this case, the above configuration that can suppress an increase in the physical size of the controller is especially useful.

### BRIEF DESCRIPTION OF DRAWINGS

FIG. 1 is a perspective view of a fuel supply device according to an embodiment;

FIG. 2 is a side view of the fuel supply device according to the embodiment;

FIG. 3 is a cross-sectional view showing an example of a fuel pump;

FIG. 4 is a top view of a set plate;

FIG. 5 is a first side view of the set plate and a connecting member;

FIG. 6 is a second side view of the set plate and the connecting member;

FIG. 7 is an enlarged cross-sectional view for a support member, the connecting member, a conductive member, and a ground member;

FIG. 8 is an enlarged view of a main part in FIG. 5, with the set plate and the connecting member omitted;

FIG. 9 is an enlarged view of a main part in FIG. 6, with the set plate and the connecting member omitted; and

FIG. 10 is a perspective view of a fuel supply device according to another embodiment.

### DESCRIPTION OF EMBODIMENTS

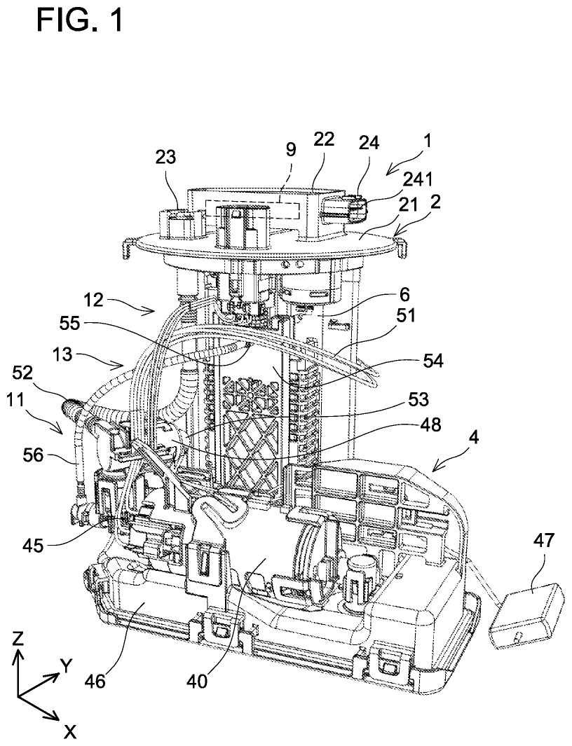

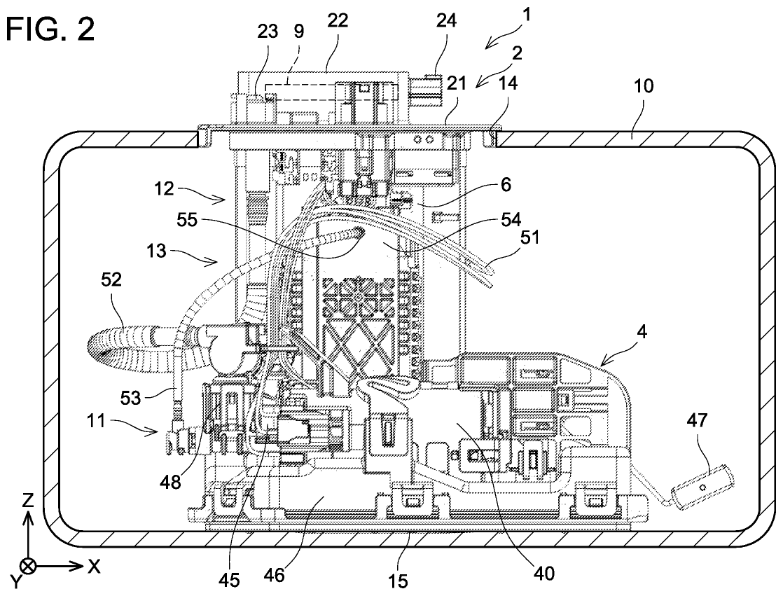

A fuel supply device according to an embodiment will be described with reference to the drawings. As shown in FIG. 1, a fuel supply device 1 according to the embodiment includes a lower unit 11 and an upper unit 12. The lower unit 11 and the upper unit 12 are connected together by a connecting portion 13. As shown in FIG. 2, the fuel supply device 1 is installed in a fuel tank 10. The fuel supply device 1 is a device configured to eject fuel in the fuel tank 10 and supply the fuel to outside of the fuel tank 10. The fuel supply device 1 is mounted on a vehicle and supplies the fuel to an engine of the vehicle.

The fuel tank 10 is a container constituted of resin or metal. The fuel tank 10 stores liquid fuel therein. The liquid fuel is, for example, gasoline. The fuel tank 10 is mounted on the vehicle. The fuel tank 10 is provided with an opening 14. The opening 14 is provided in an upper portion of the fuel tank 10. The inside and outside of the fuel tank 10 communicate with each other through the opening 14. The opening 14 is directed upward in a state where the fuel tank 10 is mounted on the vehicle. The fuel tank 10 includes a bottom portion 15.

First, the lower unit 11 of the fuel supply device 1 will be described. The lower unit 11 is disposed on the bottom portion 15 of the fuel tank 10. The lower unit 11 includes a pump unit 4, a support member 54, and a sender gauge 47.

The pump unit 4 is disposed in the fuel tank 10. The pump unit 4 is disposed on the bottom portion 15 of the fuel tank 10. The pump unit 4 includes a sub-tank 46, a fuel pump 40, and a pressure regulator 48.

The sub-tank 46 is disposed on the bottom portion 15 of the fuel tank 10. The sub-tank 46 stores a part of the fuel in the fuel tank 10. The sub-tank 46 includes a filter (not shown). The filter of the sub-tank 46 removes impurities contained in the fuel. When a part of the fuel in the fuel tank 10 flows into the sub-tank 46, impurities contained in the fuel are removed by the filter.

The fuel pump 40 is disposed above the sub-tank 46. The fuel pump 40 is fixed to the sub-tank 46. The fuel pump 40 draws in the fuel in the sub-tank 46, boosts the pressure of the fuel and ejects the fuel.

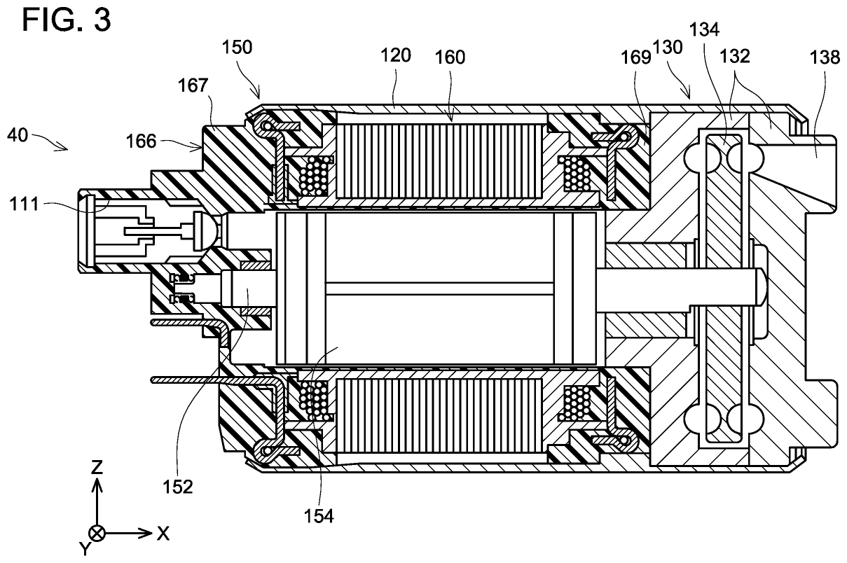

An example of the fuel pump 40 will be described below. As shown in FIG. 3, the fuel pump 40 includes a motor portion 150 and a pump portion 130. The motor portion 150 and the pump portion 130 are disposed in a housing 120. The housing 120 has a cylindrical shape with both ends thereof opened.

The pump portion 130 includes a casing 132 and an impeller 134. The casing 132 closes a lower-end opening of the housing 120. A suction port 138 is provided at the lower end of the casing 132. The suction port 138 is connected to inside of the sub-tank 46, which is described above, by a pipe (not shown). The fuel in the sub-tank 46 is drawn through the suction port 138 into the pump portion 130. An upper end of the casing 132 is provided with a communication hole (not shown) that communicates inside of the casing 132 with the motor portion 150. The impeller 134 is accommodated in the casing 132.

The motor portion 150 is a brushless motor, specifically, a three-phase motor. The motor portion 150 includes a rotor 154 and a stator 160. The rotor 154 includes a permanent magnet. A shaft 152 passes through and is fixed to a center of the rotor 154. A lower end of the shaft 152 is inserted into and passes through a center part of the impeller 134. The rotor 154 is supported by bearings disposed respectively at both ends of the shaft 152 so as to be rotatable about the shaft 152. The stator 160 includes a resin layer 166.

The resin layer 166 includes an upper-end resin portion 167 and a lower-end resin portion 169 which are disposed at an upper end and a lower end of the stator 160, respectively. The upper-end resin portion 167 closes an upper-end opening of the housing 120. An ejection port 111 is provided at an upper surface of the upper-end resin portion 167. The ejection port 111 communicates the motor portion 150 with a pipe 45 located outside the fuel pump 40 (see FIGS. 1 and 2). The ejection port 111 is an opening for ejecting the fuel, of which pressure was boosted by the pump portion 130, to the pipe 45. In the resin layer 166, the ejection port 111 and a portion of the resin layer 166 covering the stator 160 are integrally molded with resin.

The pressure regulator 48 shown in FIGS. 1 and 2 is connected to the fuel pump 40 via the pipe 45. The fuel ejected from the fuel pump 40 flows into the pressure regulator 48 through the pipe 45. Further, an ejection pipe 52 and a discharge pipe 53 are connected to the pressure regulator 48. The fuel that had flown from the fuel pump 40 into the pressure regulator 48 flows out to the ejection pipe 52 and the discharge pipe 53 from the pressure regulator 48. The pressure regulator 48 is a device configured to regulate the pressure of the fuel ejected from the fuel pump 40. When the pressure of the fuel ejected from the fuel pump 40 is lower than a predetermined pressure, the pressure regulator 48 discharges all the fuel to the ejection pipe 52. On the other hand, when the pressure of the fuel ejected from the fuel pump 40 is higher than the predetermined pressure, the pressure regulator 48 discharges a part of the fuel to the ejection pipe 52 and discharges the other part of the fuel to the discharge pipe 53. The pressure regulator 48 regulates the pressure of the fuel by discharging the fuel to the ejection pipe 52 and the discharge pipe 53.

The ejection pipe 52 is connected to an ejection port 23 of a set plate 2 which is to be described later. The fuel discharged from the pressure regulator 48 to the ejection pipe 52 is fed to the ejection port 23 through the ejection pipe 52. The fuel discharged from the pressure regulator 48 to the discharge pipe 53 is returned to the sub-tank 46. Further, a leak pipe 56 is provided at the pipe 45 to branch therefrom, and fuel discharged to the leak pipe 56 is fed to a discharge port 55.

The support member 54 is fixed to the sub-tank 46 of the pump unit 4. The support member 54 extends from the sub-tank 46 toward the set plate 2. The support member 54 supports a connecting member 6, which is to be described later, of the upper unit 12. The support member 54 includes the discharge port 55. The leak pipe 56 described above is connected to the discharge port 55. The discharge port 55 is an outlet for discharging the fuel, which had been discharged from the pressure regulator 48 to the leak pipe 56, into the fuel tank 10. The discharge port 55 is provided at a position opposite to a conductive member 7 which is to be described later. The fuel fed to the discharge port 55 through the leak pipe 56 is discharged from the discharge port 55 toward the conductive member 7.

The sender gauge 47 is attached to the sub-tank 46 of the pump unit 4. The sender gauge 47 is a device configured to detect a liquid level of the fuel in the fuel tank 10. The sender gauge 47 is configured to move up and down following the liquid level of the fuel in the fuel tank 10.

Next, the upper unit 12 of the fuel supply device 1 will be described. The upper unit 12 is attached to the opening 14 of the fuel tank 10. The upper unit 12 includes the set plate 2, a controller 9, the connecting member 6, and the conductive member 7.

The set plate 2 is disposed above the pump unit 4. The set plate 2 is attached to the upper portion of the fuel tank 10. The set plate 2 is fixed at the opening 14 of the fuel tank 10. The set plate 2 includes a flange 21, an accommodation portion 22, the ejection port 23, and an electrical connector 24.

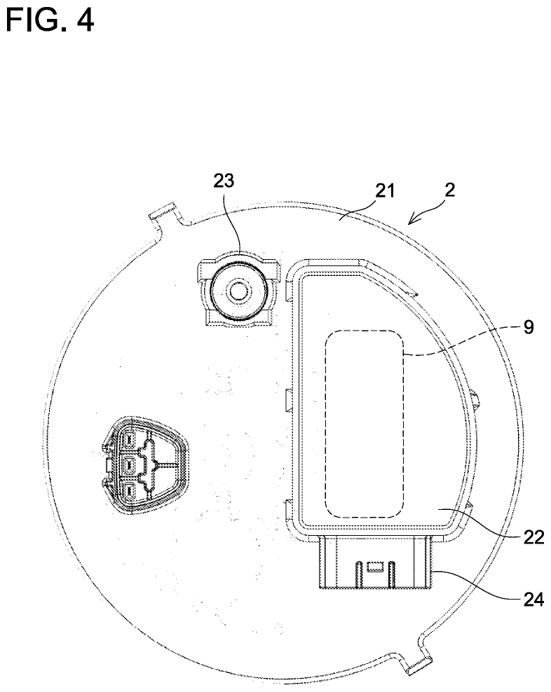

The flange 21 covers the opening 14 of the fuel tank 10. The flange 21 is fixed to the upper portion of the fuel tank 10. As shown in FIG. 4, the flange 21 has a substantially circular shape in its planer view.

The accommodation portion 22 is fixed to an upper surface of the flange 21. The accommodation portion 22 protrudes upward from the flange 21. The accommodation portion 22 is disposed outside the fuel tank 10. The accommodation portion 22 is a portion that accommodates the controller 9 therein. The accommodation portion 22 covers the controller 9. The accommodation portion 22 has a box shape.

The ejection port 23 is an outlet for ejecting the fuel, which had been ejected from the fuel pump 40 in the fuel tank 10, to the outside of the fuel tank 10. The ejection port 23 has a supply pipe (not shown) connected thereto, and the fuel ejected from the ejection port 23 is supplied to the outside of the fuel tank 10 through the supply pipe. The supply pipe (not shown) is connected to, for example, the engine of the vehicle, and the fuel is supplied to the engine of the vehicle through the supply pipe.

The electrical connector 24 includes a terminal 241 (see FIG. 1). The terminal 241 is electrically connected to the controller 9 accommodated in the accommodation portion 22 described above. Further, an electrical wiring (not shown) is connected to the terminal 241. Electric power is supplied to the controller 9 through the electrical wiring and terminal 241. The other end of the electrical wiring is connected to, for example, a battery of the vehicle, and the electric power is supplied from the battery to the controller 9 through the electric wiring.

The controller 9 is fixed to the set plate 2. The controller 9 is accommodated in the accommodation portion 22 of the set plate 2. The controller 9 is disposed outside the fuel tank 10. The controller 9 has a configuration in which a plurality of electronic components is mounted on a substrate. The controller 9 is configured to control electric power supplied to the fuel pump 40 of the pump unit 4. The controller 9 supplies three-phase AC power to the motor portion 150 (brushless motor) of the fuel pump 40. The electric power supplied to the controller 9 via the terminal 241 of the electrical connector 24 described above is supplied from the controller 9 to the fuel pump 40. The electric power is supplied from the controller 9 to the fuel pump 40 via the conductive member 7 and a harness 51, which will be described later.

The connecting member 6 is disposed between the set plate 2 and the pump unit 4. The connecting member 6 is disposed in the fuel tank 10. The connecting member 6 is a substantially plate-shaped member constituted of resin. The connecting member 6 extends in a depth direction of the fuel tank 10. The connecting member 6 connects the set plate 2 and the pump unit 4. An upper end portion of the connecting member 6 is fixed to the flange 21 of the set plate 2. A lower end portion of the connecting member 6 is connected to the support member 54 of the pump unit 4. The connecting member 6 is configured to move up and down relative to the support member 54. Thereby, the connecting member 6 and the set plate 2 move up and down relative to the pump unit 4. The set plate 2 and the pump unit 4 are connected via the connecting member 6 and the support member 54. The connecting member 6 extends in a vertical direction in a state where the vehicle on which the fuel supply device 1 is mounted is traveling on a horizontal surface. The conductive member 7 is fixed to the connecting member 6.

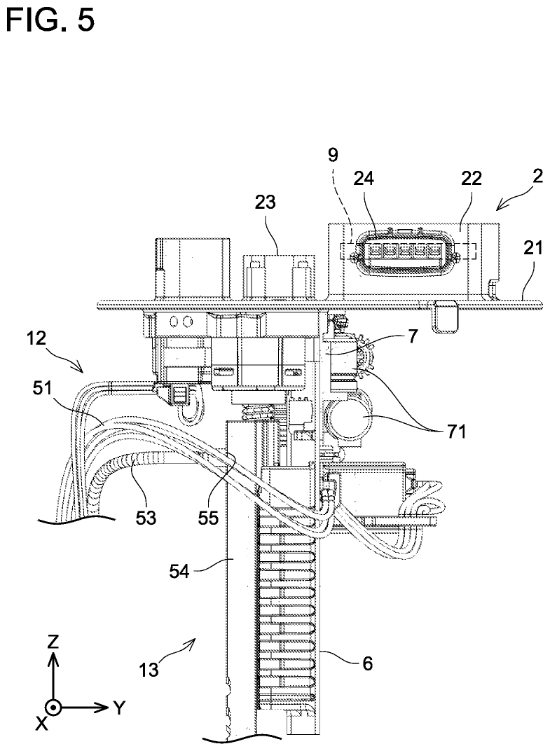

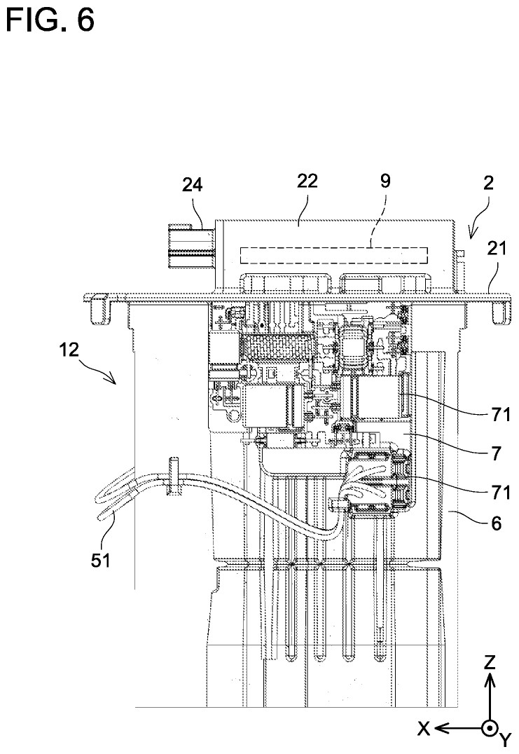

As shown in FIGS. 5 and 6, the conductive member 7 extends along the connecting member 6. The conductive member 7 extends in the depth direction of the fuel tank 10. The conductive member 7 is disposed in the fuel tank 10. The conductive member 7 is disposed between the set plate 2 and the pump unit 4. The conductive member 7 is electrically connected to the controller 9 fixed to the set plate 2.

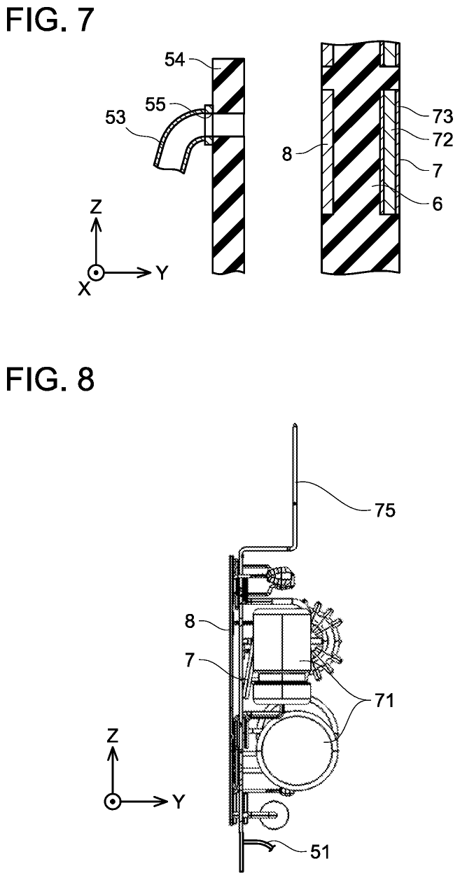

As shown in FIG. 7, the conductive member 7 is embedded in the connecting member 6. The conductive member 7 is insert-molded into the connecting member 6. The conductive member 7 includes a base member 72 constituted of a copper-based material and a coating member 73 constituted of a tin-based material and coating the base member 72. Examples of the copper-based material include brass, phosphor bronze and the like. The base member 72 is protected by the coating member 73. In the present embodiment, tin (Sn) is plated on a surface of the base member 72.

The conductive member 7 is disposed at a position opposite to the discharge port 55 of the support member 54 described above. The conductive member 7 and the discharge port 55 are opposed to each other with the connecting member 6 interposed therebetween. The fuel discharged from the discharge port 55 cools the conductive member 7. The conductive member 7 is cooled by the fuel via the connecting member 6.

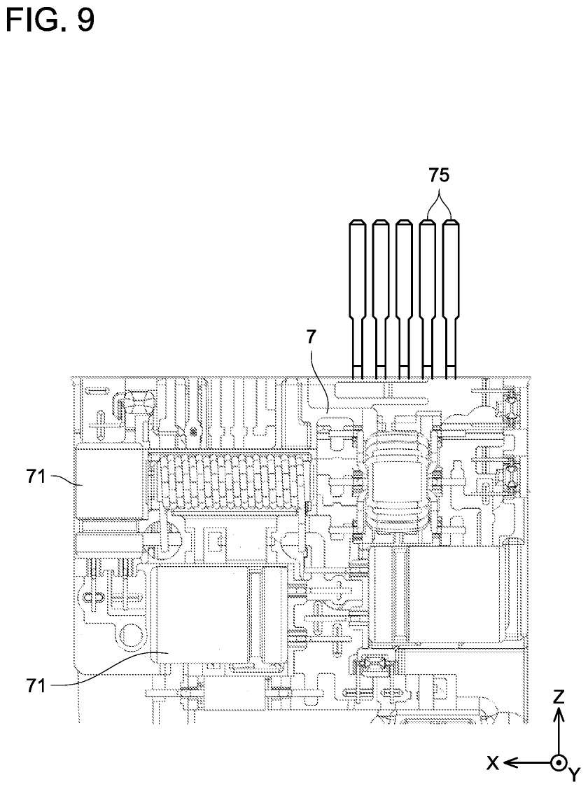

As shown in FIGS. 8 and 9, the conductive member 7 includes a plurality of terminals 75. The plurality of terminals 75 is electrically connected to the controller 9. Further, a plurality of electronic components 71 is fixed to the conductive member 7. The electronic components 71 are components of a noise filter configured to remove noise occurring when the controller 9 supplies electric power to the motor portion 150 of the fuel pump 40. The plurality of electronic components 71 constitutes the noise filter. The electronic components 71 are, for example, a capacitor, a coil, and the like. The plurality of electronic components 71 is disposed below the plurality of terminals 75 connected to the controller 9. The noise filter is disposed below the accommodation portion 22 of the set plate 2. Further, one end of the harness 51 is connected to the conductive member 7. The other end of the harness 51 is connected to the fuel pump 40 of the pump unit 4 described above. The electric power is supplied from the controller 9 to the fuel pump 40 via the conductive member 7 and the harness 51.

A ground member 8 is disposed next to the conductive member 7. The ground member 8 has conductivity. The ground member 8 is connected to a ground terminal (not shown) of the controller 9. The ground member 8 is a member configured to electrically ground the controller 9. The ground member 8 extends from the controller 9 along the connecting member 6 within the fuel tank 10. The ground member 8 is fixed to the connecting member 6. As shown in FIG. 7, the ground member 8 is embedded in the connecting member 6. The ground member 8 is insert-molded into the connecting member 6. The connecting member 6, the conductive member 7, and the ground member 8 extend, side by side, in the depth direction of the fuel tank 10. The connecting member 6, the conductive member 7, the ground member 8, and the electronic components 71 are arranged in a direction orthogonal to the depth direction of the fuel tank 10.

As is apparent from the above description, the fuel supply device 1 according to the embodiment is a device configured to eject the fuel in the fuel tank 10 mounted on the vehicle and supply the fuel to the outside of the fuel tank 10. The fuel supply device 1 includes the pump unit 4 disposed in the fuel tank. The pump unit 4 includes the fuel pump 40 that ejects the fuel in the fuel tank 10. Further, the fuel supply device 1 includes the set plate 2 fixed at the opening 14 of the fuel tank 10 and the controller 9 fixed to the set plate 2 outside the fuel tank 10. The controller 9 controls the electric power supplied to the fuel pump 40. The fuel supply device 1 includes the connecting member 6 that extends from the set plate 2 toward the pump unit 4 within the fuel tank 10. The connecting member 6 connects the set plate 2 and the pump unit 4. Further, the fuel supply device 1 includes the conductive member 7 that extends from the controller 9 along the connecting member 6 within the fuel tank 10. The conductive member 7 is fixed to the connecting member 6. The electronic components 71 are fixed to the conductive member 7.

With such a configuration, the number of electronic components in the controller 9 located outside the fuel tank 10 can be reduced. That is, since the electronic components 71 are fixed to the conductive member 7 extending from the controller 9 in the configuration described above, the electronic components 71 (e.g., a capacitor, a coil, and the like), which are conventionally fixed to the controller 9, are fixed to the conductive member 7, which can reduce the number of electronic components in the controller 9. The electronic components 71 fixed to the conductive member 7 are accommodated in the fuel tank 10 because the conductive member 7 extends within the fuel tank 10. Thereby, an increase in a physical size of the controller 9 located outside the fuel tank 10 can be suppressed.

In the fuel supply device 1 described above, the conductive member 7 extends in the vertical direction. In the vehicle on which the fuel supply device 1 is mounted, an antenna may be installed at an upper portion of the vehicle in the vertical direction (for example, at a roof of the vehicle) in order to receive external radio waves. Further, in the fuel supply device 1 including the conductive member 7, noise may occur from the conductive member 7. For example, when three-phase AC power is supplied to the fuel pump 40 via the conductive member 7, noise may occur from the conductive member 7. At this time, if the noise occurring from the conductive member 7 is radiated in the vertical direction, there is a possibility that the antenna installed at the upper portion of the vehicle in the vertical direction is thereby adversely affected. However, since the conductive member 7 extends in the vertical direction in the configuration described above, the noise occurring from the conductive member 7 is radiated in the direction orthogonal to the vertical direction (i.e., in the horizontal direction). Consequently, the noise occurring from the conductive member 7 can be suppressed from adversely affecting the antenna of the vehicle.

Further, in the fuel supply device 1 described above, the conductive member 7 is embedded in the connecting member 6. With such a configuration, the conductive member 7 and the connecting member 6 are integrated with each other, thus a space occupied by the conductive member 7 and the connecting member 6 in the fuel tank 10 can be reduced.

Furthermore, in the fuel supply device 1 described above, the electronic components 71 fixed to the conductive member 7 are components of the noise filter (for example, a capacitor, a coil, and the like) that removes the noise occurring when the electric power is supplied to the fuel pump 40. With such a configuration, the noise filter can be disposed in the fuel tank 10. Since the noise filter does not need to be disposed outside the fuel tank 10, a configuration outside the fuel tank 10 can be reduced in size. Therefore, an increase in the physical size of the controller 9 can be suppressed.

Further, the fuel supply device 1 described above includes the ground member 8 connected to the ground terminal of the controller 9. The ground member 8 extends from the controller 9 along the connecting member 6 within the fuel tank 10 and is fixed to the connecting member 6. With such a configuration, since the ground member 8 extends from the controller 9 within the fuel tank 10, the ground member 8 is not disposed outside the fuel tank 10, which can reduce the size of configuration outside the fuel tank 10. Therefore, an increase in the physical size of the controller 9 can be suppressed.

In the fuel supply device 1 described above, the conductive member 7 includes the base member 72 constituted of the copper-based material and the coating member 73 constituted of the tin-based material and coating the base member 72. Such a configuration can improve resistance of the conductive member 7 to the fuel (for example, gasoline) in the fuel tank 10.

In the fuel supply device 1 described above, the pump unit 4 is configured to discharge a part of the fuel ejected from the fuel pump 40 toward the conductive member 7. With such a configuration, the conductive member 7 can be cooled by the fuel discharged toward the conductive member 7.

In the fuel supply device 1 described above, the fuel pump 40 includes a brushless motor. In the case where the fuel pump 40 includes the brushless motor, the configuration of the controller 9 that controls the electric power supplied to the fuel pump 40 could be complicated and the physical size of the controller 9 could be large, compared to a case where the fuel pump does not include a brushless motor (for example, in a case with a motor with a brush). That is, the configuration of the controller 9 could be complicated to supply the three-phase AC power to the brushless motor. In this case, the above configuration that can suppress an increase in the physical size of the controller 9 is especially useful.

Although one embodiment has been described above, specific aspects are not limited to the embodiment described above. In the following description, configurations same as those in the above description will be denoted with the same reference signs and the description thereof will be omitted.

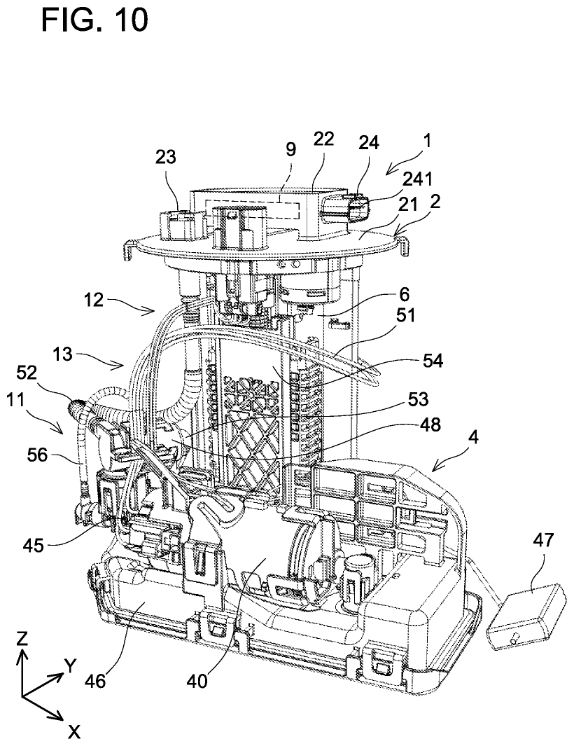

In the above embodiment, a part of the fuel ejected from the fuel pump 40 is discharged toward the conductive member 7, however, no limitation is placed thereto. In another embodiment, the fuel may not be discharged toward the conductive member 7. In this embodiment, as shown in FIG. 10, a discharge port is not provided in the support member 54. Further, the leak pipe 56 is not connected to a discharge port. The leak pipe 56 discharges the fuel into the sub-tank 46.

Specific examples of the present disclosure have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

### REFERENCE SIGNS LIST

1: Fuel Supply Device
2: Set Plate
4: Pump Unit
6: Connecting Member
7: Conductive Member
8: Ground Member
9: Controller
10: Fuel Tank
11: Lower Unit
12: Upper Unit
13: Connecting Portion
14: Opening
15: Bottom Portion
21: Flange
22: Accommodation Portion
23: Ejection Port
24: Electrical Connector
40: Fuel Pump
45: Pipe
46: Sub-tank
47: Sender Gauge
48: Pressure Regulator
51: Harness
52: Ejection Pipe
53: Discharge Pipe
54: Support Member
55: Discharge Port
71: Electronic Components
72: Base Member
73: Coating Member
75: Terminals

1. A fuel supply device configured to eject fuel in a fuel tank and supply the fuel to outside of the fuel tank, the fuel supply device comprising:
a pump unit disposed in the fuel tank and comprising a fuel pump configured to eject the fuel in the fuel tank;
a set plate fixed at an opening of the fuel tank;
a controller fixed on the set plate outside the fuel tank and configured to control electric power supplied to the fuel pump;
a connecting member extending from the set plate toward the pump unit within the fuel tank and connecting the set plate and the pump unit; and
a conductive member having an electric component fixed thereon, extending from the controller along the connecting member within the fuel tank, and fixed to the connecting member.

2. The fuel supply device according to claim 1, wherein the conductive member extends in a vertical direction.

3. The fuel supply device according to claim 1, wherein the conductive member is embedded in the connecting member.

4. The fuel supply device according to claim 1, wherein the electric component is a component of a noise filter configured to remove noise occurring when the electric power is supplied to the fuel pump.

5. The fuel supply device according to claim 1, further comprising a ground member connected to a ground terminal of the controller,
wherein the ground member extends from the controller along the connecting member within the fuel tank and is fixed to the connecting member.

6. The fuel supply device according to claim 1, wherein the conductive member comprises a base member constituted of a copper-based material, and a coating member constituted of a tin-based material and coating the base member.

7. The fuel supply device according to claim 1, wherein the pump unit is configured to discharge a part of fuel ejected from the fuel pump toward the conductive member.

8. The fuel supply device according to claim 1, wherein the fuel pump comprises a brushless motor.
